(19) United States
(12) Patent Application Publication
(10) Pub. No.: US 2017/0120373 A1
(43) Pub. Date: May 4, 2017

(54) FRICTION STIR WELDING MACHINE HAVING A ROTATABLE ANVIL AND ASSOCIATED METHOD

(71) Applicant: The Boeing Company, Chicago, IL (US)

(72) Inventor: Paul Dylan Edwards, Seattle, WA (US)

(21) Appl. No.: 14/931,168

(22) Filed: Nov. 3, 2015

(51) Int. Cl. B23K 20/12

(52) U.S. Cl. CPC B23K 20/122; B23K 20/1255; B23K 20/1205; B23K 20/1265

(57) ABSTRACT

A friction stir welding machine and a method of friction stir welding a workpiece are provided. In this regard, a friction stir welding machine is provided that includes a weld fixture comprising first and second arms configured to be positioned on opposite sides of a workpiece. The friction stir welding machine also includes a weld tool carried by the first arm of the weld fixture and configured to be inserted into and rotated relative to the workpiece. The friction stir welding machine further includes a rotatable anvil carried by the second arm of the weld fixture and configured to be positioned in cooperative engagement with the workpiece in an aligned relationship to the weld tool. The rotatable anvil is configured to react forces applied to the workpiece by the weld tool and to be rotated as the weld fixture is moved relative to the workpiece.

### TECHNICAL FIELD

A self-reacting friction stir welding machine and associated method are provided in order to support movement of the friction stir welding machine relative to a workpiece in order to form, for example, a continuous weld.

### BACKGROUND

Friction stir welding is a solid state joining process. During friction stir welding, a weld tool is inserted into and urged against a workpiece, while the weld tool is rotated. The rotation of the weld tool creates heat which softens the region of the workpiece in the vicinity of the weld tool. Additionally, the rotation of the weld tool mechanically intermixes the material that forms the workpiece. In order to join two or more workpieces by friction stir welding, the weld tool may be inserted at or through the interface between the workpieces such that material from the regions of the two workpieces in the vicinity of the interface is intermixed. On removal of the weld tool, the intermixed material hardens, thereby forming a weld joint or seam that joins the workpieces.

Friction stir welding oftentimes requires robust tooling, such as monolithic hard tooling, to react to the forces imparted upon the workpiece by the weld tool. Traditionally, the hard tooling has been relatively substantial in order to react to the forces imparted by the weld tool, thereby increasing the costs associated with the hard tooling and the friction stir welding operation. Additionally, the hard tooling is generally only useful for supporting workpieces having a shape that matches the shape of the hard tooling, thereby limiting the workpieces with which hard tooling may be utilized and correspondingly reducing the flexibility and increasing the costs of friction stir welding operations that re designed to weld differently shaped workpieces.

Robotic friction stir welding techniques have also been developed, such as for joining relatively soft metallic alloys, such as aluminum. Robotic friction stir welding still generally requires relatively cumbersome tooling to fixture the workpiece that is to be welded and to react to the forces imparted by the weld tool. As noted above, the tooling utilized by robotic friction stir welding must also be specifically designed and constructed for each differently shaped workpiece since the shape of the workpiece and the shape of the tooling must match, thereby increasing the cost and reducing the flexibility of robotic friction stir welding.

In order to mitigate against the limitations imposed by such cumbersome tooling, bobbin tools have been developed. A bobbin tool includes a weld tool that is inserted into and rotatably advanced through a workpiece. The weld tool generally includes a first shoulder that urged against and that maintains contact with a first surface of the workpiece and a pin extending from the first shoulder and into the workpiece. The bobbin tool also includes a second shoulder that is attached to the weld tool and is positioned adjacent to and in contact with a second surface of the workpiece, opposite the first surface. The second shoulder of the bobbin tool is integral with the weld tool with the second shoulder configured to react to the forces applied to the workpiece by the weld tool. Thus, the bobbin tool is self-reacting so as to eliminate the need for hard tooling, although other tooling may be required to fixture the workpiece during friction stir welding operations.

Additionally, robotic friction stir spot welding systems have been developed that are self-reacting. Robotic friction stir spot welding systems include a fixture configured to hold both the weld tool and a pin in an opposed relationship. The weld tool and the pin are configured to engage opposite surfaces of the workpiece during friction stir welding operations. Thus, the pin reacts to the forces applied to the workpiece by the weld tool such that the robotic friction stir spot welding system also reduces the reliance upon hard tool by being self-reacting. However, the utility of a robotic friction stir spot welding system is limited in that a robotic friction stir spot welding system may only be utilized to form discrete spot welds.

### BRIEF SUMMARY

A friction stir welding machine and a method of friction stir welding a workpiece are provided in order to reduce reliance upon hard tooling, even in instances in which the friction stir welding machine is moved relative to the workpiece so as to form a continuous weld. In an example embodiment, the friction stir welding machine is self-reacting so as to internally support the forces applied to the workpiece by the weld tool during friction stir welding operations. By reducing reliance upon hard tooling, the friction stir welding machine and the method of friction stir welding a workpiece may friction stir weld a variety of workpieces in a more economical and flexible manner.

In an example embodiment, a friction stir welding machine is provided that includes a weld fixture comprising first and second arms configured to be positioned on opposite sides of a workpiece. The friction stir welding machine also includes a weld tool carried by the first arm of the weld fixture and configured to be inserted into a workpiece and to be rotated relative to the workpiece. The friction stir welding machine further includes a rotatable anvil, such as a wheel, carried by the second arm of the weld fixture and configured to be positioned in cooperative engagement with the workpiece in an aligned relationship to the weld tool. The rotatable anvil is configured to react forces applied to the workpiece by the weld tool and to be rotated as the weld fixture is moved relative to the workpiece.

The rotatable anvil of an example embodiment has a curved peripheral surface configured to be positioned in cooperative engagement with the workpiece. In this example embodiment, the curved peripheral surface of the rotatable anvil may be configured to make contact with the workpiece at one or more points of contact. The weld tool and the rotatable anvil of this example embodiment are thereby maintained in the aligned relationship such that the one or more points of contact remain in alignment with the weld tool. The rotatable anvil of an example embodiment has a cylindrical shape. As such, the rotatable anvil of this example embodiment defines an axis of rotation and the rotatable anvil may be configured to be positioned relative to the workpiece such that the axis of rotation of the rotatable anvil is parallel to a surface of the workpiece. In an example embodiment, the weld fixture also includes an interconnecting portion extending between the first and second arms and configured to be engaged by a robot. The rotatable anvil of this example embodiment defines its axis of rotation so as to extend toward the interconnecting portion. The interconnecting portion may also include an interface configured to be engaged by the robot.

In another embodiment, a friction stir welding machine is provided that includes a weld tool configured to be inserted into a workpiece from a first side thereof and to be rotated relative to the workpiece. The friction stir welding machine also includes a rotatable anvil, such as a wheel, having a curve peripheral surface configured to be positioned in cooperative engagement with the second side of the workpiece, opposite the first side. The rotatable anvil is configured to react forces applied to the workpiece by the weld tool and to be rotated as the weld tool is moved relative to the workpiece.

The curved peripheral surface of the rotatable anvil of an example embodiment is configured to make contact with the workpiece at one or more points of contact. The weld tool and the rotatable anvil of this example embodiment are maintained in an aligned relationship such that the one or more points of contact are in alignment with the weld tool. The rotatable anvil of an example embodiment has a cylindrical shape and defines an axis of rotation. Thus, the rotatable anvil of this example embodiment is configured to be positioned relative to the workpiece such that the axis of rotation of the rotatable anvil is parallel to a surface of the workpiece. The friction stir welding machine of an example embodiment also includes a weld fixture that maintains the weld tool and the rotatable anvil in an aligned relationship such that the axis of rotation of the rotatable anvil extends towards the weld fixture. The weld fixture of this example embodiment may also include an interface configured to be engaged by the robot.

In a further embodiment, a method of friction stir welding a workpiece is provided that includes inserting a weld tool into the workpiece and engaging a first side of the workpiece while rotating the weld tool relative to the workpiece. The method of friction stir welding also include cooperatively engaging a second side of the workpiece, opposite the first side, with a rotatable anvil so as to react forces applied to the workpiece by the weld tool. The method of friction stir welding further includes moving the weld tool and the rotatable anvil relative to the workpiece while maintaining the weld tool and the rotatable anvil in alignment. The rotatable anvil of this example embodiment is caused to be rotated as the weld tool and rotatable anvil are moved relative to the workpiece.

The rotatable anvil of an example embodiment defines an axis of rotation. Thus, the method of friction stir welding of an example embodiment moves the weld tool and the rotatable anvil in a direction perpendicular to the axis of rotation of the rotatable anvil. The rotatable anvil of an example embodiment has a curved peripheral surface. Thus, the method of friction stir welding of an example embodiment moves the weld tool and the rotatable anvil so as to cause the rotatable anvil to be rotated in order to bring different portions of the curved peripheral surface into contact with the workpiece. The curved peripheral surface of the rotatable anvil is configured to make contact with the workpiece at one or more points of contact. Thus, the method of friction stir welding of an example embodiment maintains the weld tool and the rotatable anvil in alignment by maintaining one or more points of contact in alignment with the weld tool as the weld tool and rotatable anvil are moved relative to the workpiece. The method of friction stir welding of an example embodiment moves the weld tool and the rotatable anvil along the length of the workpiece so as to form a continuous weld. The method of friction stir welding of an example embodiment moves the weld tool and the rotatable anvil while maintaining the workpiece in a stationary position.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a side view of a friction stir welding machine in accordance with an example embodiment of the present disclosure;

FIG. 2 is a perspective view of the friction stir welding machine of FIG. 1 following engagement by a robot in accordance with an example embodiment of the present disclosure;

FIG. 3 is a simplified side view of a friction stir welding machine in accordance with an example embodiment of the present disclosure;

FIG. 4 is a cross-sectional view of the friction stir welding machine during friction stir welding of a workpiece in accordance with an example embodiment to the present disclosure; and

FIG. 5 is a perspective view depicting a continuous weld formed by a friction stir welding machine in accordance with an example embodiment of the present disclosure.

### DETAILED DESCRIPTION

The present disclosure now will be described more fully hereinafter with reference to the accompanying drawings, in which some, but not all aspects are shown. Indeed, the disclosure may be embodied in many different forms and should not be construed as limited to the aspects set forth herein. Rather, these aspects are provided so that this disclosure will satisfy applicable legal requirements. Like numbers refer to like elements throughout.

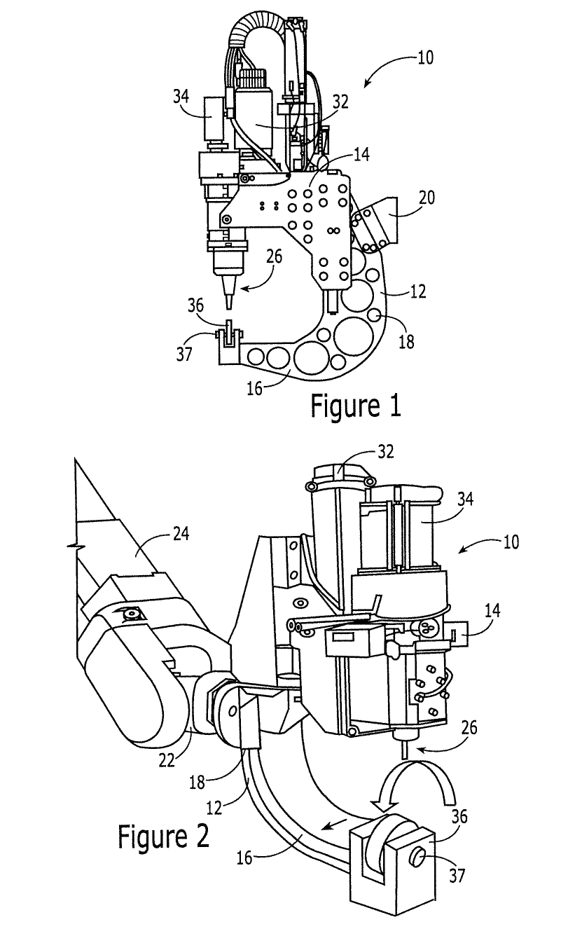

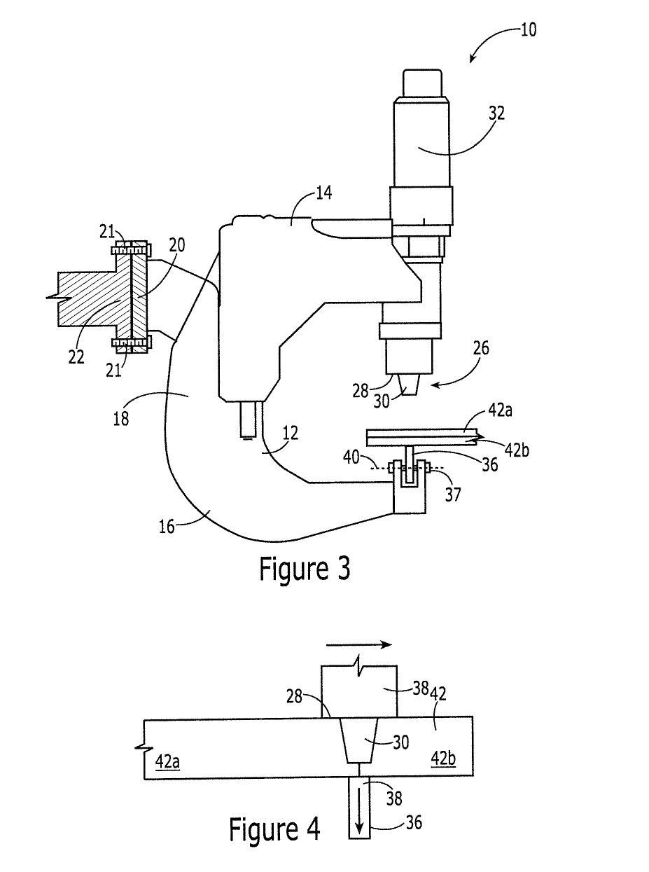

A friction stir welding machine 10 in accordance with an example embodiment is depicted in FIG. 1. As shown, the friction stir welding machine 10 includes a weld fixture 12 that, in turn, includes first and second arms 14, 16 configured to be positioned on opposite sides of a workpiece, such as a workpiece 42 as shown in FIG. 3. The weld fixture 12 of the illustrated embodiment also includes an interconnecting portion 18 extending between and joined to the first and second arms 14, 16. In the illustrated embodiment, the weld fixture 12 including the first and second arms 14, 16 and the interconnecting portion 18 may be an integral structure. Alternatively, the different components of the weld fixture 12 may be discrete and may be assembled in the manner described above. The weld fixture 12 of FIG. 1 has a C-shape, e.g., an at least partially arcuate shape that includes a gap. However, the weld fixture 12 may have other shapes, such as a more rectilinear shape, in other embodiments. Although the weld fixture 12 may be utilized in various manners, the friction stir welding machine 10 of an example embodiment is configured to be utilized in conjunction with robotic friction stir welding. Thus, the weld fixture 12 of the illustrated embodiment includes an interface 20, such as an interface carried by the interconnecting portion 18 of the weld fixture. The interface 20 has a size and shape that is configured to be securely engaged by the end effector 22 carried by an arm 24 of a robot, such as shown in FIG. 2. Although the interface 20 may be configured in various manners, the interface of an example embodiment may be configured as a four bolt type interface with the size of the interface and the bolts 21 being proportional to the expected welding loads, as shown, for example, in FIG. 3.

The friction stir welding machine 10 also includes a weld tool 26 that is carried by the first arm 14 of the weld fixture 12. The weld tool 26 is configured to be inserted into the workpiece and to be rotated relative to the workpiece in order to create frictional heating within the workpiece and to intermix different regions of the materials of the workpiece that have been softened by the frictional heating. As shown in more detail in FIG. 4, the weld tool 26 includes a shoulder 28 that is configured to engage a first surface of the workpiece 42 and a pin 30 extending from and having a smaller diameter than the first shoulder of the weld tool. The pin 30 is configured to be inserted into the workpiece 42 while both the shoulder 28 and the pin are rotated. In this regard, FIG. 4 depicts a weld tool 26 having a shoulder 28 for physically engaging a first surface of the workpiece 42 and a pin 30 that has been inserted into and is rotated within the workpiece 42. Although the pin 30 may be cylindrical, the pin may have other shapes including, for example, the frustoconical shape shown in FIGS. 3 and 4.

The weld tool 26 may be extended relative to the weld fixture 12 so as to be plunged or inserted into the workpiece 42 and rotated relative to the workpiece 42 in various manners. In the example embodiment of FIGS. 1 and 2, however, the friction stir welding machine 10 includes a motor 32 for rotating the weld tool 26 and a hydraulic or pneumatic cylinder 34 for controllably extending the weld tool 26 relative to the weld fixture 12 in order to plunge the tool into the workpiece. In operation, the friction between the workpiece and tool 26 softens the workpiece and causes the workpiece material, e.g., metal, to be stirred together and joined. The forcing of the tool 26 into the workpiece to accomplish the welding results in forces that are reacted by the end effector holding the weld tool and the fixture 12 on the opposite side of the workspace from the weld tool.

In accordance with an example embodiment, the friction stir welding machine 10 also includes a rotatable anvil 36. The rotatable anvil 36 is carried by the second arm 16 of the weld fixture 12 and, as such, the rotatable anvil 36 is positioned proximate the opposite surface of the workpiece 42 from the surface that the shoulder 28 of the weld tool 26 engages. The rotatable anvil 36 may be engaged by the second arm 16 in various manners, but is connected to the second arm by a pin 37 in the example embodiment depicted in FIGS. 1-3. As shown in FIG. 4, the rotatable anvil 36 is configured to be positioned in cooperative engagement with the workpiece 42. In this regard, the rotatable anvil 36 may be positioned in physical contact with the workpiece 42 or may be separated from the workpiece 42 by one or more intervening layers while still maintaining cooperative engagement therewith by applying force to the workpiece 42 through the intervening layers. Additionally, the rotatable anvil 36 is configured to be positioned in an aligned relationship to the weld tool 26. As shown in FIG. 4, for example, the rotatable anvil 36 may be configured so as to make contact with the workpiece 42 at one or more points of contact. As such, the weld tool 26 and the rotatable anvil 36 may be maintained by the weld fixture 12 in the aligned relationship, even as the friction stir welding machine 10 is moved relative to the workpiece 42, such that the one or more points of contact of the rotatable anvil are in alignment with the weld tool 26.

As a result of the positional alignment of the rotatable anvil 36 with the weld tool 26 and the cooperative engagement of the workpiece 42 by the rotatable anvil 36, the rotatable anvil 36 is configured to react to and correspondingly offset the forces applied to the workpiece 42 by the weld tool 26. Thus, the friction stir welding machine 10 of an example embodiment is self-reacting. The friction stir welding machine 10 therefore supports friction stir welding operations without the hard tooling that may otherwise be required to react the forces applied by the weld tool 26 with the rotatable anvil 36, instead, serving to react to the forces.

The rotatable anvil 36 may be configured in various manners. For example, the rotatable anvil 36 may be a wheel. As such, the rotatable anvil 36 of the example embodiment depicted in FIG. 4 has a curved peripheral surface 38 that is configured to be positioned in cooperative engagement with the workpiece 42 and to thereby make contact with the workpiece 42 at one or more points of contact, such as a line of contact. In this regard, the rotatable anvil 36 may have a cylindrical shape with the curved peripheral surface 38 extending circumferentially about the cylindrically shaped anvil.

The rotatable anvil 36 of this example embodiment defines an axis 40 of rotation, such as defined by the pin 37 in the example embodiments of FIGS. 1-3, about which the cylindrically shaped anvil rotates. The axis 40 of rotation is defined axially through the center of the rotatable anvil 36 so as to be parallel to the cylindrical shape defined by the curved peripheral surface 38. As shown in FIGS. 1-3, the rotatable anvil 36 is carried by the second arm 16 of the weld fixture 12 such that the rotatable anvil 36 is, in turn, positioned relative to the workpiece 42 such that the axis 40 of rotation of the rotatable anvil 36 is parallel to the surface of the workpiece 42, such as the surface of the workpiece 42 engaged by the rotatable anvil 36. Stated another way, the axis 40 of rotation defined by the rotatable anvil 36 generally extends toward the interconnecting portion 18 of the weld fixture 12, such as by extending along the second arm 16 toward the interconnecting portion 18 of the weld fixture 12.

The friction stir welding machine 10 is configured such that the weld fixture 12 as well as the weld tool 26 and the rotatable anvil 36 carried by the weld fixture 12, are movable relative to the workpiece 42 during friction stir welding operations. Thus, the rotatable anvil 36 is carried by the second arm 16 of the weld fixture 12 such that the axis 40 of rotation extends perpendicular to the anticipated direction in which the friction stir welding machine 10 will be moved relative to the workpiece 42. With respect to the embodiment of FIG. 4, for example, the friction stir welding machine 10 is configured to be moved perpendicular to, that is, into and out of, the page. Thus, the rotatable anvil 36 will rotate as the weld fixture 12 is moved with respect to the workpiece 42 so as to maintain cooperative engagement with the workpiece 42 in an aligned relationship to the weld tool 10.

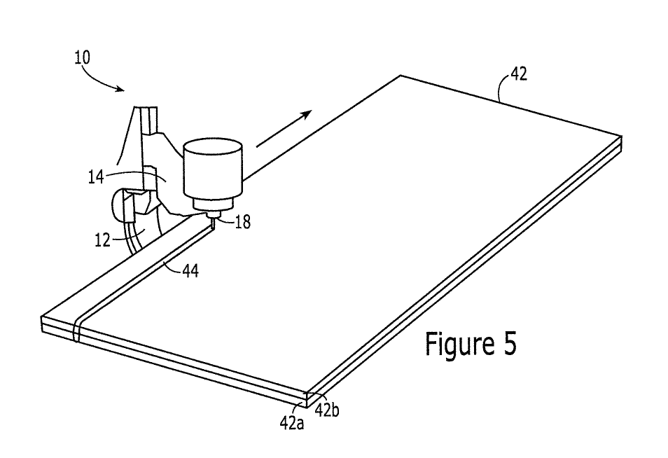

In operation, the weld tool 26 and, in particular, the pin 30 may be inserted in to the workpiece 42 such that the weld tool 26, such as a shoulder 28 of the weld tool 26, engages a first surface of the workpiece 42 while the weld tool 26 is rotated relative to the workpiece 42. The weld tool 26 may be inserted into a variety of workpieces 42 including a variety of metallic workpieces, such as workpieces formed of various metallic alloys including aluminum. As the friction stir welding machine 10 is generally utilized to join two or more components 42a and 42b to form a unified workpiece, the weld tool 26 of the example embodiment is inserted into or through an interface between the different components such that subsequent rotation and movement of the weld tool 26 along and through the interface will cause material from the different components to intermix such that the components are joined by a weld once the material has cooled. By way of example, FIG. 4 depicts two components 42a and 42b positioned side-by-side with the pin 30 of the weld tool 26 inserted into the interface defined therebetween so as to form a butt weld, while FIGS. 3 and 5 depicts two components 42a and 42b stacked one on top of the other with the pin 30 of the weld tool extending through the interface defined between the components 42a and 42b so as to form a lap weld. With respect to the embodiment of FIG. 4, component 42b has a smaller width than component 42a so as to fit within the weld fixture 12 during the friction stir welding operation.

While the weld tool 26 is inserted into and is rotating relative to the workpiece 42, a second surface of the workpiece 42, opposite the first surface that is engaged by the shoulder 28 of the weld tool 26, is cooperatively engaged by a rotatable anvil 36, as shown in FIG. 3. The rotatable anvil 36 serves to react to forces applied to the workpiece 42 by the weld tool 26 such that the friction stir welding machine 10 is self-reacting and the requirement for hard tooling is reduced or eliminated. The weld tool 26 and the rotatable anvil 36 are thereafter moved, such as by movement of the weld fixture 12, relative to the workpiece 42 while maintaining the weld tool 26 and the rotatable anvil 36 in alignment and while continuing to rotate the weld tool 26 with the weld tool 26 and the rotatable anvil 36 in engagement with opposite surfaces of the workpiece 42. In this regard, the weld tool 26 and the rotatable anvil 36 may be moved in a direction perpendicular to the axis 40 of rotation of the rotatable anvil 36 such that the rotatable anvil 36 rotates relative to the workpiece 42 as the weld tool 26 and the rotatable anvil 36 are moved with respect to the workpiece 42 while maintaining cooperative engagement of the second surface of the workpiece 42 with the rotatable anvil 36. As a result of the rotation of the rotatable anvil 36 during movement of the weld tool 26 and the rotatable anvil 36 with respect to the workpiece 42, different portions of the curved peripheral surface 38 of the rotatable anvil 36 are brought into contact with the workpiece 42.

As shown in FIG. 5, the weld tool 26 and the rotatable anvil 36 may be moved along a length of the workpiece 42 to form a continuous lap weld 44, such as a seam weld, which joins two or more components 42a and 42b together along the seam. While moving the weld tool 26 and the rotatable anvil 36, the workpiece 42 may be maintained in the stationary position with the relative movement being brought about by the movement of the weld tool 26 and the rotatable anvil 36 in concert with one another. By permitting the workpiece 42 to remain stationary during formation of the weld, the tooling for supporting the workpiece 42 may be simplified. Thus, the friction stir welding machine 10 permits the formation of continuous welds 44 while reducing or eliminating the hard tooling that is required to react the forces created by the weld tool 26 as a result of the self-reacting configuration of the friction stir welding machine.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

1. A friction stir welding machine comprising:
a weld tool configured to be inserted into a workpiece from a first side thereof and to be rotated relative to the workpiece; and
a rotatable anvil having a curved peripheral surface configured to be positioned in cooperative engagement with a second side of the workpiece, opposite the first side,
wherein the rotatable anvil is configured to react forces applied to the workpiece by the weld tool and to be rotated as the weld tool is moved relative to the workpiece.

2. A friction stir welding machine of claim 1 wherein the curved peripheral surface of the rotatable anvil is configured to make contact with the workpiece at one or more points of contact, and wherein the weld tool and the rotatable anvil are maintained in an aligned relationship such that the one or more points of contact are in alignment with the weld tool.

3. A friction stir welding machine of claim 1 wherein the rotatable anvil has a cylindrical shape.

4. A friction stir welding machine of claim 3 wherein the rotatable anvil defines an axis of rotation, and wherein the rotatable anvil is configured to be positioned relative to the workpiece such that the axis of rotation of the rotatable anvil is parallel to a surface of the workpiece.

5. A friction stir welding machine of claim 3 wherein the rotatable anvil defines an axis of rotation, wherein the friction stir welding machine further comprises a weld fixture that maintains the weld tool and the rotatable anvil in an aligned relationship, and wherein the rotatable anvil defines an axis of rotation that extends toward the weld fixture.

6. A friction stir welding machine of claim 5 wherein the weld fixture comprises an interface configured to be engaged by the robot.

7. A friction stir welding machine comprising:
a weld fixture comprising first and second arms configured to be positioned on opposite sides of a workpiece;
a weld tool carried by the first arm of the weld fixture and configured to be inserted into the workpiece and to be rotated relative to the workpiece; and
a rotatable anvil carried by the second arm of the weld fixture and configured to be positioned in cooperative engagement with the workpiece in an aligned relationship to the weld tool,
wherein the rotatable anvil is configured to react forces applied to the workpiece by the weld tool and to be rotated as the weld fixture is moved relative to the workpiece.

8. A friction stir welding machine of claim 7 wherein the rotatable anvil has a curved peripheral surface configured to be positioned in cooperative engagement with the workpiece.

9. A friction stir welding machine of claim 8 wherein the curved peripheral surface of the rotatable anvil is configured to make contact with the workpiece at one or more points of contact, and wherein the weld tool and the rotatable anvil are maintained in the aligned relationship such that the one or more points of contact are in alignment with the weld tool.

10. A friction stir welding machine of claim 8 wherein the rotatable anvil has a cylindrical shape.

11. A friction stir welding machine of claim 10 wherein the rotatable anvil defines an axis of rotation, and wherein the rotatable anvil is configured to be positioned relative to the workpiece such that the axis of rotation of the rotatable anvil is parallel to a surface of the workpiece.

12. A friction stir welding machine of claim 10 wherein the weld fixture further comprises an interconnecting portion extending between the first and second arms and configured to be engaged by a robot, and wherein the rotatable anvil defines an axis of rotation that extends toward the interconnecting portion.

13. A friction stir welding machine of claim 12 wherein the interconnecting portion comprises an interface configured to be engaged by the robot.

14. A friction stir welding machine of claim 7 wherein the rotatable anvil comprises a wheel.

15. A method of friction stir welding a workpiece, the method comprising:
inserting a weld tool into the workpiece and engaging a first side of the workpiece while rotating the weld tool relative to the workpiece;
cooperatively engaging a second side of the workpiece, opposite the first side, with a rotatable anvil so as to react forces applied to the workpiece by the weld tool; and
moving the weld tool and the rotatable anvil relative to the workpiece while maintaining the weld tool and the rotatable anvil in alignment, wherein moving the weld tool and the rotatable anvil comprises causing the rotatable anvil to be rotated as the weld tool and the rotatable anvil are moved relative to the workpiece.

16. A method of friction stir welding of claim 15 wherein the rotatable anvil defines an axis of rotation, and wherein moving the weld tool and the rotatable anvil comprises moving the weld tool and the rotatable anvil in a direction perpendicular to the axis of rotation of the rotatable anvil.

17. A method of friction stir welding of claim 15 wherein the rotatable anvil has a curved peripheral surface, and wherein moving the weld tool and the rotatable anvil comprises causing the rotatable anvil to be rotated so as to bring different portions of the curved peripheral surface into contact with the workpiece.

18. A method of friction stir welding of claim 17 wherein the curved peripheral surface of the rotatable anvil is configured to make contact with the workpiece at one or more points of contact, and wherein maintaining the weld tool and the rotatable anvil in alignment comprises maintaining one or more points of contact in alignment with the weld tool as the weld tool and the rotatable anvil are moved relative to the workpiece.

19. A method of friction stir welding of claim 15 wherein moving the weld tool and the rotatable anvil comprises moving the weld tool and the rotatable anvil along a length of the workpiece to form a continuous weld.

20. A method of friction stir welding of claim 15 wherein moving the weld tool and the rotatable anvil comprises maintaining the workpiece in a stationary position as the weld tool and the rotatable anvil are moved relative thereto.
